(19) United States
(12) Patent Application Publication
(10) Pub. No.: US 2007/0223339 A1
(43) Pub. Date: Sep. 27, 2007

(54) METHOD AND APPARATUS FOR ADJUSTING BUFFERING OF DATA READ FROM OPTICAL STORAGE MEDIUM BY COMPARING ACTUAL POSITION INFORMATION WITH EXPECTED POSITION INFORMATION

(76) Inventors: Li-Lien Lin, Hsin-Chu City (TW); Jin-Bin Yang, Changhua County (TW); Shih-Hsin Chen, Tao-Yuan Hsien (TW)

Correspondence Address: NORTH AMERICA INTELLECTUAL PROPERTY CORPORATION, P.O. BOX 506, MERRIFIELD, VA, 22116, US

(21) Appl. No.: 11/308,366

(22) Filed: Mar. 19, 2006

(51) Int. Cl. G11B 27/36

(52) U.S. Cl. 369/53.31

(57) ABSTRACT

A method for buffering data read from an optical storage medium. The method includes: reading a second data segment from the optical storage medium; and setting a second expected position information corresponding to the second data segment for aligning the second expected position information to a second actual position information of the second data segment, and buffering the second data segment read from the optical storage medium into a storage device according to the second expected position information.

### BACKGROUND

This invention relates to data buffering, and more particularly, to methods and apparatuses for adjusting buffering of data read from an optical storage medium by comparing actual position information with expected position information.

The basic storage data set stored in a digital versatile disc (DVD) is a block. One block contains sixteen sectors, and each sector is designated by corresponding position information, i.e. sector ID. In general, the sector ID of a next sector is greater than that of a current sector by one. For example, the block N has sixteen sectors wherein sector IDs are from 123400, 123401, . . . , to 12340f. In Blu-Ray discs (BD), the basic storage data set is a cluster. One cluster contains sixteen units, and each unit is designated by corresponding position information, i.e. an address unit number (aun). In general, the aun of a next unit is greater than that of a current unit by two. For example, the cluster N has sixteen units wherein address unit numbers are from 12340, 12342, . . . , to 12345e.

When an optical disc, such as a DVD or a BD, is inserted into an optical disc drive, the optical disc drive starts reading data stored on the optical disc and then transfers a read data to a host. In general, the data read from the optical disc is firstly stored in a memory of the optical disc drive, known as a buffer memory, for undergoing decoding or transmitting. If the data is shifted or slipped during the reading operation and the optical disc drive continues data buffering, the data read from the optical disc will be stored in erroneous positions, resulting in decoding and transmitting failure.

Taking the data access of a BD for example, when the blank area of a BD is being read, the address unit number of each unit is unable to be identified. Therefore, the actual address unit number of the unit read after the blank area has been accessed may not match an expected value, and therefore the data of the unit read from the optical disc will be stored in an erroneous position of the buffer memory. When this happens, if the related art optical disc drive continues buffering following data read from the BD, the data buffered in erroneous positions will cause decoding errors. As a result, since the buffered data of a cluster cannot be decoded correctly, the related art optical disc drive deems that the data on the BD are not correctly read, and then re-buffers data of the same cluster on the BD.

However, if the related art optical disc drive stops buffering data read from the BD and then re-buffers data of the same cluster when the mismatch between the actual address unit number and an expected address unit number of the unit read from the BD is acknowledged, the defect management becomes complicated due to the interrupt of data buffering. In other words, re-buffering the data still has the possibility to buffer the re-buffered data into incorrect positions of the buffer memory.

Data accessing of DVDs has the same disadvantages as mentioned above. Therefore, how to buffer data read from an optical disc into correct positions of a buffer memory plays an important role in data decoding and data transmitting.

### SUMMARY

It is therefore one of the objectives of the claimed invention to provide a method and apparatus for adjusting buffering of data read from an optical storage medium by comparing actual position information with expected position information, to solve the above problems.

According to an embodiment of the claimed invention, a method for buffering data read from an optical storage medium is disclosed. The method comprises: reading a second data segment from the optical storage medium; and setting a second expected position information corresponding to the second data segment for aligning the second expected position information to a second actual position information of the second data segment, and buffering the second data segment read from the optical storage medium into a storage device according to the second expected position information.

According to an embodiment of the claimed invention, a data buffering apparatus for buffering data read from an optical storage medium is disclosed. The data buffering apparatus comprises: a storage device; a buffer controller for reading a second data segment from the optical storage medium; and a decision logic, coupled to the buffer controller, for setting a second expected position information corresponding to the second data segment for aligning the second expected position information to a second actual position information of the second data segment and controls the buffer controller to buffer the second data segment read from the optical storage medium into a storage device according to the second expected position information.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a data buffering system according to an embodiment of the present invention.

FIG. 2 is a flowchart illustrating an operation of adjusting the buffering of data read from an optical storage medium according to an embodiment of the present invention.

FIG. 3 is a diagram illustrating a first embodiment of adjusting the data buffering in the storage device shown in FIG. 1.

FIG. 4 is a diagram illustrating a second embodiment of adjusting the data buffering in the storage device shown in FIG. 1.

FIG. 5 is a diagram illustrating a third embodiment of adjusting the data buffering in the storage device shown in FIG. 1.

FIG. 6 is a diagram illustrating a fourth embodiment of adjusting the data buffering in the storage device shown in FIG. 1.

FIG. 7 is a diagram illustrating a fifth embodiment of adjusting the data buffering in the storage device shown in FIG. 1.

FIG. 8 is a diagram illustrating a sixth embodiment of adjusting the data buffering in the storage device shown in FIG. 1.

### DETAILED DESCRIPTION

Please note that certain terms are used throughout the following description and claims to refer to particular system components. As one skilled in the art will appreciate, consumer electronic equipment manufacturers may refer to a component by different names. This document does not intend to distinguish between components that differ in name but not function. In the following discussion and in the claims, the terms “including” and “comprising” are used in an opened-ended fashion, and thus should be interpreted to mean “including, but not limited to . . . ”. Also, the term “couple” or “couples” is intended to mean either an indirect or direct electrical connection. Thus, if a first device couples to a second device, that connection may be through a direct electrical connection, or through an indirect electrical connection via other devices and connections.

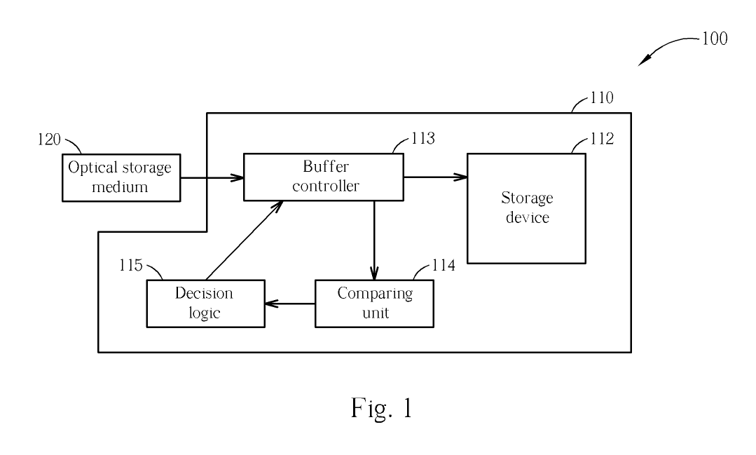

Please refer to FIG. 1. FIG. 1 is a block diagram of a data buffering system 100 according to an embodiment. The data buffering system 100 includes an optical storage medium 120 and a data buffering apparatus 110 used to access data recorded on the optical storage medium 120.

As shown in FIG. 1, the data buffering apparatus 110 includes a storage device 112, a buffer controller 113, a comparing unit 114 and a decision logic 115. In this embodiment, the storage device 112 acts as a memory for data buffering. The buffer controller 113 is coupled to the storage device 112, for controlling data buffering of the storage device 112. The comparing unit 114 compares actual position information of the data read from the optical storage medium 120 and expected position information of the data to be stored in the storage device 112. The decision logic 115 is coupled to the comparing unit 114 and the buffer controller 113, and controls the buffer controller 113 to adjust the data buffering according to the comparison result provided by the comparing unit 114.

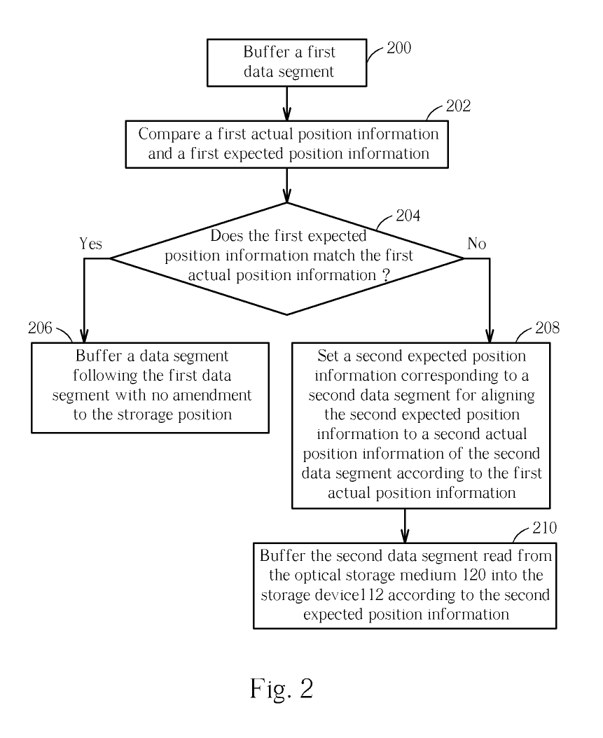

Please refer to FIG. 2. FIG. 2 is a flowchart illustrating operation of adjusting the buffering of data read from an optical storage medium 120 according to an embodiment of the present invention. Adjusting the data buffering of the data includes the following steps:

Step 200: Buffer a first data segment read from an optical storage medium 120, such as a DVD or a BD, into the storage device 112.

Step 202: Compare a first actual position information of the first data segment read from the optical storage medium 120 with a first expected position information of the first data segment to be stored in the storage device 112.

Step 204: Does the first expected position information match the first actual position information? If yes, go to step 206; otherwise, go to step 208.

Step 206: Buffer a data segment following the first data segment into the storage device 112 with no amendment to the expected storage position of the data segment.

Step 208: Set a second expected position information corresponding to a second data segment for aligning the second expected position information to a second actual position information of the second data segment according to the first actual position information.

Step 210: buffer the second data segment read from the optical storage medium 120 into the storage device 112 according to the second expected position information.

Please note that the second data segment is read from the optical storage medium 120 after the first data segment is read from the optical storage medium 120. In addition, the optical disc drive has a counter mechanism for counting the data segments read from the optical storage medium 120 to determine the expected position information to which the optical disc drive refers when buffering the data segments. For example, the buffer controller 113 in FIG. 1 is designed to count the incoming data segments and increment the expected position information each time a data segment is received for buffering.

In this embodiment, the buffer controller 113 buffers the first data segment into the storage device 112 (step 200), and then the comparing unit 114 compares the first actual position information and the first expected position information to generate a comparison result (step 202). If the decision logic 115 acknowledges that the first expected position information matches the first actual position information when referring to the comparison result (step 204), the decision logic 115 allows the buffer controller 113 to buffer the data segment following the first data segment into the storage device 112 with no amendment made to the storage position. For example, the following data segment read from the optical storage medium 120 is stored next to the first data segment (actual position). However, if the decision logic 115 acknowledges that the first actual position information does not match the first expected position information when referring to the comparison result (step 204), the decision logic 115 controls the buffer controller 113 to set a second expected position information corresponding to a second data segment for aligning the second expected position information to a second actual position information of the second data segment according to the first actual position information and then buffer the second data segment read from the optical storage medium 120 into the storage device 112 according to the second expected position information. As a result, the expected position information and the actual position information of the buffered data are aligned.

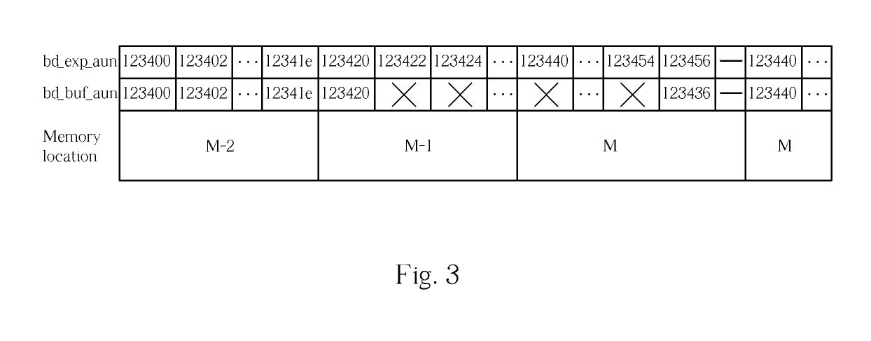

For clarity, a plurality of examples are given as follows to illustrate the operation of adjusting the buffering of data read from an optical disc (e.g. a BD or a DVD). Please refer to FIG. 3. FIG. 3 is a diagram illustrating a first embodiment of adjusting the data buffering in the storage device 112 shown in FIG. 1. In this embodiment, the optical storage medium 120 is a BD, each data segment mentioned above is a unit, and the position information is the address unit number (aun). As shown in FIG. 3, bd_exp_aun represents the expected address unit number of the unit stored in the storage device 112, which is generated by the counter according to the starting bd_exp_aun, while bd_buf_aun represents the actual address unit number of the unit read from the BD. An optical disc drive accesses data read from the BD, and buffers the data read from the BD into the storage device 112 for following data decoding and transmitting. As shown in FIG. 3, a cluster N−2 containing sixteen units of address unit numbers 123400-12341e is stored in the memory location M−2 of the storage device 112. In other words, memory areas in the storage device 112, corresponding to expected address unit numbers 123400-12341e, are defined to store the units of actual address unit numbers 123400-12341e read from the BD. However, as known to those skilled in this art, the optical disc drive fails to resolve the actual address unit number when accessing the blank area on the BD, and the unrecognizable actual address unit number, as shown in FIG. 3, is designated by “x”. When the blank area has been accessed, a unit following the blank area is read from the BD, and the unit with an actual address unit number 123436 (i.e. the aforementioned first data segment) is stored into a memory area of memory location M while the expected address unit number is 123456. The comparing unit 114 shown in FIG. 1 detects the mismatch between the expected address unit number 123456 and the actual address unit number 123436, and then notifies the decision logic 115 of the comparison result. It is clear that the actual address unit number 123436 belongs to a unit of a previous cluster N−1 that should be buffered in the memory location M−1 of the storage device 112. Since the units read from the BD are sequentially accessed and the actual address unit number 123436 belongs to a unit of a previous cluster N−1, the initial unit of the cluster N to be buffered in the memory location M, i.e. the unit of the expected address unit number 123440, has not been read from the BD yet.

In this embodiment, the decision logic 115 refers to the actual address unit number 123436 to determine the following unit with the actual address unit number 123440 to be buffered into memory location M. Then, after receiving the desired unit of the target address unit number 123440, the buffer controller 113 issues commands to the storage device 112 for storing the desired unit of the target address unit number 123440 into the memory location M of the storage device 112 as the leading unit stored therein.

In addition, the decision logic 115 sets 123440 as the expected address unit number for a target unit, and stops the buffer controller 113 from buffering following units read from the BD into the storage device 112 until the target unit of the actual address unit number 123440 (i.e. the aforementioned second data segment) is received. Therefore, when the target unit of the actual address unit number 123440 is received, the target unit is stored in a memory area of memory location M that corresponds to the expected address unit number 123440. In other words, the buffer controller 113 stores the unit of the actual address unit number 123440 into a correct position of the storage device 112. As a result, the mismatch between the actual address unit number and the expected address unit number is cancelled by adjusting the expected address unit number of the storage position of the initial unit of a cluster N in the storage device 112.

As mentioned above, the data buffering is stopped as the mismatch between the actual address unit number and the expected address unit number is detected. However, the buffer controller 113, depending on design requirements, could keep buffering following units read from the BD into erroneous positions before the target unit having the actual address unit number 123440 is received. Since the comparing unit 114 keeps monitoring the occurrence of the mismatch between the actual address unit number and the expected address unit number, it is clear that the target unit having the actual address unit number 123440 will be stored in the memory area of memory location M that corresponds to the expected address unit number 123440.

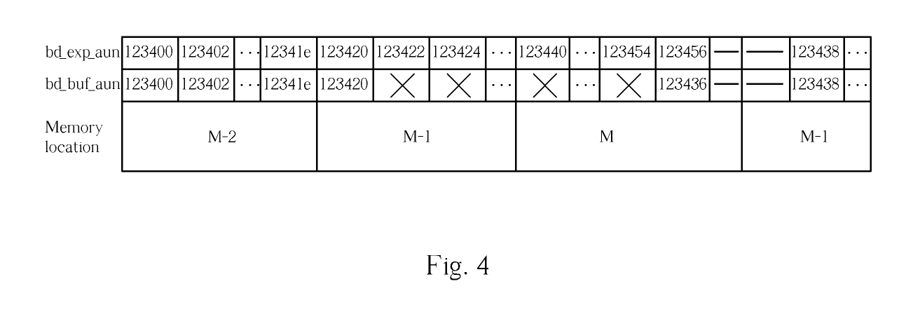

In the above example, aligning of the actual address unit number and the expected address unit number is performed upon the initial unit of a cluster N. However, the present invention is not limited to this aligning scheme. Please refer to FIG. 4. FIG. 4 is a diagram illustrating a second embodiment of adjusting the data buffering in the storage device 112 shown in FIG. 1. In this embodiment, the comparing unit 114, similarly, detects the mismatch between the actual address unit number and the expected address unit number when the unit of the actual address unit 123436 (i.e. the aforementioned first data segment) is buffered into the storage device 112 by the buffer controller 113, and then notifies the decision logic 115 of the comparison result. In this embodiment, the decision logic 115 refers to the actual address unit number 123436 to determine that the actual address unit number of the following unit should be 123438. Therefore, when the unit of the actual address unit number 123438 (i.e. the aforementioned second data segment) is received, the expected address unit number is set as 123438 and then the buffer controller 113 issues commands to the storage device 112 for storing the unit of the actual address unit number 123438 in a memory area of memory location M−1 that corresponds to the expected address unit number 123438. As a result, the mismatch between the actual address unit number and the expected address unit number is cancelled by adjusting the storage position of the immediately following unit.

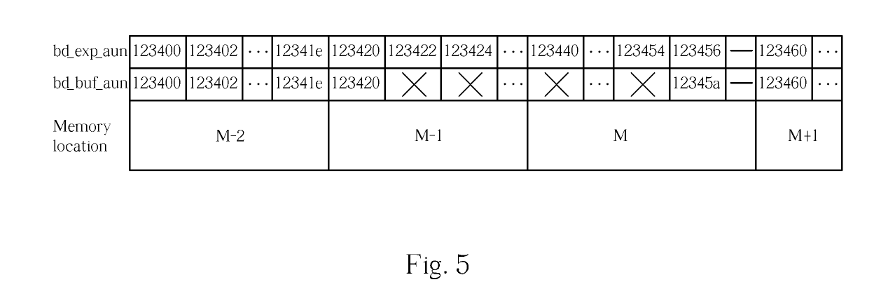

Please refer to FIG. 5. FIG. 5 is a diagram illustrating a third embodiment of adjusting the data buffering in the storage device 112 shown in FIG. 1. In this embodiment, a unit with an actual address unit number 12345a (i.e. the aforementioned first data segment) is stored into a memory area of memory location M while the expected address unit number is 123456. The comparing unit 114 shown in FIG. 1 detects the mismatch between the expected address unit number 123456 and the actual address unit number 12345a. It is clear that the actual address unit number 12345a belongs to a unit of the same cluster N to be buffered in the memory location M of the storage device 112. Moreover, the buffering of the unit with the actual address unit number 12345a implies that the initial unit of the next cluster N+1 to be buffered in the memory location M+1, i.e. the unit of the expected address unit number 123460, has not been read from the BD yet. In this embodiment, the decision logic 115 refers to the actual address unit number 12345a to determine the following unit to be with the actual address unit number 123460 and to be buffered into memory location M+1. Then, after receiving the desired unit of the target address unit number 123460, the buffer controller 113 issues commands to the storage device 112 for storing the desired unit of the target address unit number 123460 into the memory location M+1 of the storage device 112 as the leading unit stored therein.

In addition, the decision logic 115 sets 123460 as the expected address unit number for a target unit, and stops the buffer controller 113 from buffering following units read from the BD into the storage device 112 until the target unit of the actual address unit number 123460 (i.e. the aforementioned second data segment) is received. Therefore, when the target unit is received, the target unit is stored in a memory area of memory location M+1 that corresponds to the expected address unit number 123460. As a result, the mismatch between the actual address unit number and the expected address unit number is cancelled by adjusting the storage position of the initial unit of a cluster N+1 in the storage device 112.

As mentioned above, the data buffering is stopped as the mismatch between the actual address unit number and the expected address unit number is detected. However, the buffer controller 113, depending on design requirements, is allowed to keep buffering following units read from the BD into erroneous positions before the target unit having the actual address unit number 123460 is received. Since the comparing unit 114 keeps monitoring the occurrence of the mismatch between the actual address unit number and the expected address unit number to hold the target expected address unit number 123460 set to the target unit, it is clear that the target unit having the actual address unit number 123460 will be always stored in the memory area of memory location M+1 that corresponds to the expected address unit number 123460. The objective of aligning the actual address unit number and the expected address unit number is still achieved by adjusting the storage position of an initial unit of a cluster N+1.

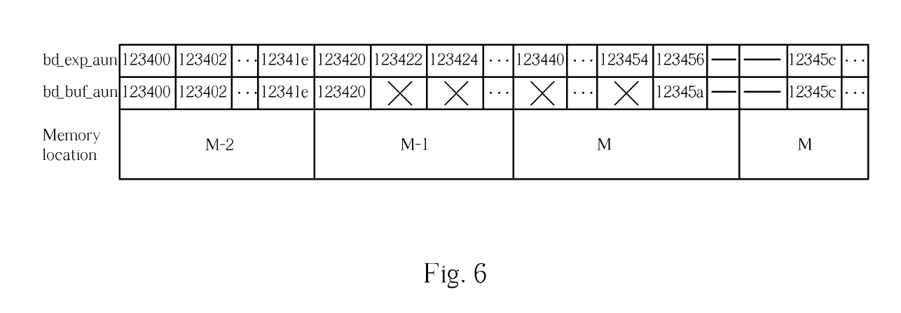

Please refer to FIG. 6. FIG. 6 is a diagram illustrating a fourth embodiment of adjusting the data buffering in the storage device 112 shown in FIG. 1. The comparing unit 114 detects the mismatch between the actual address unit number and the expected address unit number when the unit of the actual address unit 12345a (i.e. the aforementioned first data segment) is buffered into the storage device 112 by the buffer controller 113. In this embodiment, the decision logic 115 refers to the actual address unit number 12345a to determine the following unit with the actual address unit number 12345c to be buffered into the memory location M. Therefore, when the unit of the actual address unit number 12345c (i.e. the aforementioned second data segment) is received, the expected address unit number is set as 12345c and then the buffer controller 113 issues commands to the storage device 112 for storing the unit of the actual address unit number 12345c in a memory area of memory location M that corresponds to the expected address unit number 12345c. As a result, the mismatch between the actual address unit number and the expected address unit number is cancelled by adjusting the storage position of the immediately following unit.

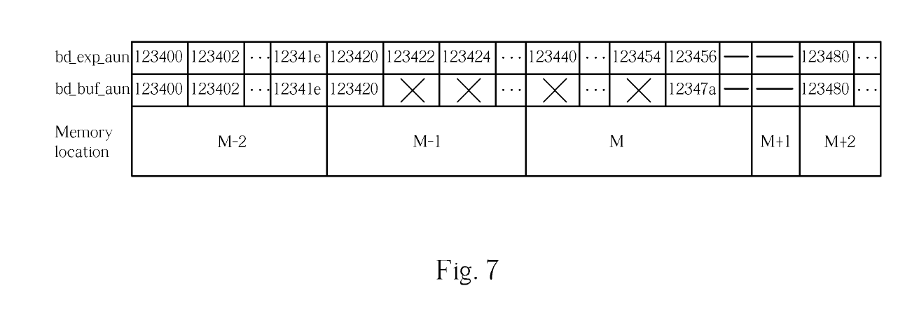

Please refer to FIG. 7. FIG. 7 is a diagram illustrating a fifth embodiment of adjusting the data buffering in the storage device 112 shown in FIG. 1. In this embodiment, a unit with an actual address unit number 12347a (i.e. the aforementioned first data segment) is stored into a memory area of memory location M while the expected address unit number is 123456. The comparing unit 114 shown in FIG. 1 detects the mismatch between the expected address unit number 123456 and the actual address unit number 12347a. It is clear that the actual address unit number 12347a belongs to a unit of the next cluster N+1 to be buffered in the memory location M+1 of the storage device 112. Moreover, the buffering of the unit with the actual address unit number 12347a implies that the initial unit of a further next cluster N+2 to be buffered in the memory location M+2, i.e. the unit of the expected address unit number 123480, has not been read from the BD yet. In this embodiment, the decision logic 115 refers to the actual address unit number 12347a to determine the following unit with the actual address unit number 123480 to be buffered into the memory location M+2. Then, after receiving the desired unit of the target address unit number 123480, the buffer controller 113 issues commands to the storage device 112 for storing the desired unit of the target address unit number 123480 into the memory location M+2 of the storage device 112 as the leading unit stored therein.

In addition, the decision logic 115 sets 123480 as the expected address unit number for a target unit, and stops the buffer controller 113 from buffering following units read from the BD into the storage device 112 until the target unit of the actual address unit number 123480 (i.e. the aforementioned second data segment) is received. Therefore, when the target unit is received, the target unit is stored in a memory area of memory location M+2 that corresponds to the expected address unit number 123480. As a result, the mismatch between the actual address unit number and the expected address unit number is cancelled by adjusting the storage position of the initial unit of a cluster N+2 in the storage device 112.

As mentioned above, data buffering is stopped as the mismatch between the actual address unit number and the expected address unit number is detected. However, the buffer controller 113, depending on design requirements, is allowed to keep buffering following units read from the BD before the desired unit having the actual address unit number 123480 is received. Since the comparing unit 114 keeps monitoring the occurrence of the mismatch between the actual address unit number and the expected address unit number, it is clear that the target unit having the actual address unit number 123480 will always be stored in the memory area of memory location M+2 that corresponds to the expected address unit number 123480. The objective of aligning the actual address unit number and the expected address unit number is still achieved by adjusting the storage position of an initial unit of a cluster N+2.

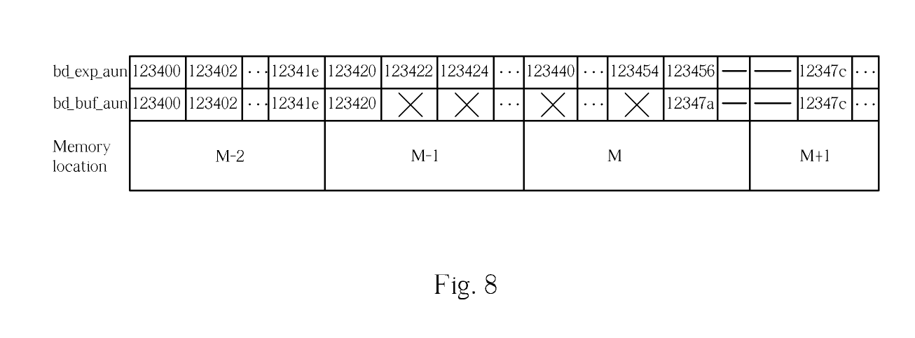

Please refer to FIG. 8. FIG. 8 is a diagram illustrating a sixth embodiment of adjusting the data buffering in the storage device 112 shown in FIG. 1. The comparing unit 114 detects the mismatch between the actual address unit number and the expected address unit number when the unit of the actual address unit 12347a (i.e. the aforementioned first data segment) is buffered into the storage device 112 by the buffer controller 113. In this embodiment, the decision logic 115 refers to the actual address unit number 12347a to determine the following unit with the actual address unit number 12347c to be buffered into the memory location M+1. Therefore, when the unit of the actual address unit number 12347c (i.e. the aforementioned second data segment) is received, the expected address unit number is set as 12347c and then the buffer controller 113 issues commands to the storage device 112 for storing the unit of the actual address unit number 12347c in a memory area of memory location M+1 that corresponds to the expected address unit number 12347c. As a result, the mismatch between the actual address unit number and the expected address unit number is cancelled by adjusting the storage position of the immediately following unit.

The above examples illustrate the operation of adjusting the buffering of data read from a BD. However, the adjusting scheme for data buffering is not limited to a BD. For example, referring to the above embodiments illustrated in FIG. 3 to FIG. 8, a skilled person can easily understand that the same scheme can be applied to adjusting the buffering of data read from a DVD by taking a sector of a block as the aforementioned data segment and the sector ID as the position information. Since data buffering adjustment scheme for a DVD is identical to that for a BD, further description for illustrating the operation of adjusting the buffering of data read from a DVD is omitted here for brevity.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for buffering data read from an optical storage medium, the method comprising:
reading a second data segment from the optical storage medium; and
setting a second expected position information corresponding to the second data segment for aligning the second expected position information to a second actual position information of the second data segment, and buffering the second data segment read from the optical storage medium into a storage device according to the second expected position information.

2. The method of claim 1, wherein the step of setting the second expected position information comprises:
comparing a first actual position information of a first data segment read from the optical storage medium and a first expected position information corresponding to the first data segment; and
if the first actual position information does not match the first expected position information, setting the second expected position information corresponding to the second data segment;
wherein the second data segment is read from the optical storage medium after the first data segment is read from the optical storage medium.

3. The method of claim 2, the step of setting the second expected position information further comprises:
determining the second expected position information according to the first actual position information of the first data segment read from the optical storage medium.

4. The method of claim 1, wherein the second data segment is immediately next to the first data segment.

5. The method of claim 1, wherein the optical storage medium is a Blu-ray disc (BD), and the first data segment is a unit and the second data segment is a unit.

6. The method of claim 1, wherein the optical storage medium is a digital versatile disc (DVD), and the first data segment is a sector and the second data segment is a sector.

7. The method of claim 1, wherein the data stored on the optical storage medium is divided into a plurality of storage data sets each having a plurality of data segments, the first data segment belongs to an Nth storage data set, and the second data segment belongs to an (N+1)th storage data set.

8. The method of claim 7, wherein the optical storage medium is a Blu-ray disc (BD), each of the storage data sets is a cluster, and each of the data segments is a unit.

9. The method of claim 7, wherein the optical storage medium is a digital versatile disc (DVD), each of the storage data sets is a block, and each of the data segments is a sector.

10. The method of claim 7, wherein the second data segment is an initial data segment of the (N+1)th storage data set.

11. The method of claim 1, wherein the storage device is a memory.

12. A data buffering apparatus for buffering data read from an optical storage medium, the data buffering apparatus comprising:
a storage device;
a buffer controller, for reading a second data segment from the optical storage medium; and
a decision logic, coupled to the buffer controller, for setting a second expected position information corresponding to the second data segment for aligning the second expected position information to a second actual position information of the second data segment and controls the buffer controller to buffer the second data segment read from the optical storage medium into a storage device according to the second expected position information.

13. The data buffering apparatus of claim 12, wherein the decision logic further comprising:
a comparing unit, for comparing a first actual position information of a first data segment read from the optical storage medium and a first expected position information corresponding to the first data segment, wherein if the first actual position information does not match the first expected position information, the decision logic sets the second expected position information corresponding to the second data segment;
wherein the second data segment is read from the optical storage medium after the first data segment is read from the optical storage medium.

14. The data buffering apparatus of claim 13, wherein the decision logic sets a second expected position information further determines the second expected position information according to the first actual position information of the first data segment read from the optical storage medium.

15. The data buffering apparatus of claim 12, wherein the second data segment is directly next to the first data segment.

16. The data buffering apparatus of claim 12, wherein the optical storage medium is a Blu-ray disc (BD), and the first data segment is a unit and the second data segment is a unit.

17. The data buffering apparatus of claim 12, wherein the optical storage medium is a digital versatile disc (DVD), and the first data segment is a sector and the second data segment is a sector.

18. The data buffering apparatus of claim 12, wherein the data stored on the optical storage medium is divided into a plurality of storage data sets each having a plurality of data segments, the first data segment belongs to an Nth storage data set, and the second data segment belongs to an (N+1)th storage data set.

19. The data buffering apparatus of claim 18, wherein the optical storage medium is a Blu-ray disc (BD), each of the storage data sets is a cluster, and each of the data segments is a unit.

20. The data buffering apparatus of claim 18, wherein the optical storage medium is a digital versatile disc (DVD), each of the storage data sets is a block, and each of the data segments is a sector.

21. The data buffering apparatus of claim 16, wherein the second data segment is an initial data segment of the (N+1)th storage data set.

22. The data buffering apparatus of claim 12, wherein the storage device is a memory.
